(19) United States
(12) Patent Application Publication
(10) Pub. No.: US 2024/0101403 A1
(43) Pub. Date: Mar. 28, 2024

(54) Adapter for lifting a vehicle using a vehicle jack

(71) Applicant: T Sportline, LLC, Downey, CA (US)

(72) Inventor: Brian Reese, Atlanta, GA (US)

(73) Assignee: T Sportline, LLC, Downey, CA (US)

(21) Appl. No.: 18/045,593

(22) Filed: Oct. 11, 2022

Related U.S. Application Data
(60) Provisional application No. 63/376,968, filed on Sep. 23, 2022.

(51) Int. Cl. B66F 13/00

(52) U.S. Cl. CPC B66F 13/00

(57) ABSTRACT

An adapter for a vehicle jack comprises a puck, a riser, and an optional nipple. The puck has a puck bottom surface, a puck top surface, and a puck sidewall having a puck first exterior dimension. The riser extends from the puck top surface and has a riser top surface and a riser sidewall having a second exterior dimension. The optional nipple extends from the riser top surface and has a nipple top surface and a nipple sidewall having a third exterior dimension. The puck bottom surface is configured to associate with a top surface of a jack pad of the vehicle jack while the nipple is configured to associate with a portion of a vehicle chassis.

### CROSS REFERENCES AND PRIORITIES

This application claims priority from U.S. Provisional Application No. 63/376,968 filed on 23 Sep. 2022, the teachings of which are incorporated by reference herein in their entirety.

### BACKGROUND

Vehicle jacks—including hydraulic floor jacks, hydraulic bottle jacks, scissor jacks, and the like—are used to lift a vehicle from the ground to effect tire changes, oil changes, and various other maintenance and repair activities. A user can position the jack underneath a lift point of the vehicle and raise the vehicle from that point by extending the jack.

Existing jacks include a jack pad—sometimes referred to as a saddle—positioned on top of a base to apply pressure to the vehicle lift point and thereby raise the vehicle. These jack pads are universal such that one jack pad is used on a variety of vehicles.

In practice, existing vehicle jacks often suffer from height limitations. For many vehicles—particularly modern pickup trucks and SUVs— the height of accessible lift points on the vehicle is close to or beyond the height that an existing vehicle jack can reach. This issue becomes exacerbated when the vehicle is modified with custom suspension components that increase the vehicle's ride height (commonly referred to as lift kits), larger wheels/tires, and the like.

Several solutions have been proposed for addressing the height limitations of existing vehicle jacks. One such solution is proposed in U.S. Pat. No. 4,964,617 A which discloses a removable extension for a hydraulic floor jack mounted on the extending end of a lifting arm upon removal of a saddle therefrom and adapted to contact the underside of a vehicle body for raising the vehicle body. The extension has a lower plate with a lower pin received within an opening on the upper horizontal web of a U-shaped mounting bracket on the extending end of the lifting arm.

Another solution is proposed in United States Patent Publication No. 2007/0235704 A1 which discloses a jack extension mounted on an industry standard hydraulic jack. The jack extension is mounted and held in place by inserting a registration pin of the jack extension into a jack mount opening of a rest plate of the hydraulic jack.

The prior art solutions suffer from several notable problems. To maintain the extensions in a secure position on the jack pad/saddle, the prior art relies upon pins or related fasteners which require increased time for the user to manually manipulate the pins/fasteners to attach and detach the extension from the jack pad/saddle. The prior art solutions are also height limited in their own right as the extension portion is of a predetermined height which cannot be increased or decreased.

The need exists, therefore, for an improved apparatus and method to increase the height that a vehicle jack can achieve when lifting a vehicle from a surface.

### SUMMARY

Disclosed herein are adapters for lifting a vehicle using a vehicle jack. One embodiment of the adapter comprises a puck, a riser, and a nipple. The puck has a puck bottom surface, a puck top surface opposite the puck bottom surface, and a puck sidewall extending between the puck bottom surface and the puck top surface. The puck sidewall has a first exterior dimension. The riser extends from the puck top surface and has a riser top surface and a riser sidewall. The riser sidewall has a second exterior dimension. The nipple extends from the riser top surface and has a nipple top surface and a nipple sidewall. The nipple sidewall has a third exterior dimension.

The nipple will have a radial cross sectional profile shape which may be selected from the group consisting of a circle, an oval, a triangle, a quadrilateral, a heptagon, a hexagon, or an octagon. In some embodiments, the nipple sidewall may comprise an o-ring groove. In such embodiments, the adapter may further comprise an o-ring connected to the nipple at the o-ring groove.

In certain embodiments where the nipple has a radial cross sectional profile shape of a circle, the nipple sidewall may be threaded. In other embodiments where the nipple has a radial cross sectional profile shape, the nipple sidewall may comprise a snap-ring groove. In such embodiments, the adapter may further comprise a snap-ring connected to the nipple at the snap-ring groove.

In some embodiments, the first exterior dimension of the puck sidewall may be greater than the second exterior dimension of the riser sidewall. In other embodiments, the first exterior dimension of the puck sidewall may be less than the second exterior dimension of the riser sidewall. In certain embodiments, the second exterior dimension of the riser sidewall may be greater than the third exterior dimension of the nipple sidewall.

In certain embodiments, the puck bottom surface may comprise a nipple receiving hole configured to receive a second nipple of a second adapter.

The adapter may comprise a rigid material selected from the group consisting of steel, aluminum, cast iron, titanium, wood, rigid polymer materials, composite materials, and combinations thereof.

In embodiments of the adapter comprising a puck, a riser, and a nipple, the puck bottom surface may be configured to associate with a top surface of a jack pad of a vehicle jack. The nipple may then be configured to associate with a portion of a vehicle chassis of a vehicle.

Another embodiment of an adapter for lifting a vehicle using a vehicle jack comprises a puck and a riser. The puck has a puck bottom surface, a puck top surface opposite the puck bottom surface, and a puck sidewall extending between the puck bottom surface and the puck top surface. The puck sidewall has a first exterior dimension. The riser extends from the puck top surface and has a riser top surface and a riser sidewall. The riser sidewall has a second exterior dimension. The riser top surface comprises a magnet.

In some such embodiments, the first exterior dimension of the puck sidewall may be greater than the second exterior dimension of the riser sidewall.

In certain embodiments, the puck bottom surface may comprise a ferromagnetic material.

In embodiments of the adapter comprising a puck and a riser, the puck bottom surface may be configured to associate with a top surface of a jack pad of the vehicle jack.

### BRIEF DESCRIPTION OF FIGURES

FIG. 1 is a perspective view of one embodiment of an adapter for a vehicle jack.

FIG. 2 is a side view of the embodiment of an adapter for a vehicle jack of FIG. 1.

FIG. 3 is a bottom view of one embodiment of an adapter for a vehicle jack.

FIG. 4 is an exploded perspective view of an embodiment of an adapter for a vehicle jack in use.

FIG. 5 is an assembled perspective view of an embodiment of an adapter for a vehicle jack in use.

FIG. 6 is a perspective view of an alternative embodiment of an adapter for a vehicle jack.

FIG. 7 is an exploded perspective view of an alternative embodiment of an adapter for a vehicle jack.

FIG. 8 is an assembled perspective view of the alternative embodiment of an adapter for a vehicle jack of FIG. 7.

FIG. 9 is a perspective view of an alternative embodiment of an adapter for a vehicle jack.

FIG. 10 is a perspective view of an alternative embodiment of an adapter for a vehicle jack.

FIG. 11 is an exploded side view of a pair of adapters connecting to one another.

### DETAILED DESCRIPTION

Disclosed herein are various embodiments of an adapter for a vehicle jack. The adapters are described below with reference to the Figures. As described herein and in the claims, the following numbers refer to the following structures as noted in the Figures.
10 refers to a vehicle jack.
15 refers to a top surface of a jack pad (of the vehicle jack).
50 refers to a vehicle chassis.
100 refers to an adapter.
110 refers to a puck.
111 refers to a puck bottom surface.
112 refers to a puck top surface.
113 refers to a puck sidewall.
114 refers to a nipple receiving hole.
120 refers to a riser.
121 refers to a riser top surface.
122 refers to a riser sidewall.
130 refers to a nipple.
131 refers to a nipple top surface.
132 refers to a nipple sidewall.
133 refers to an o-ring groove.
140 refers to an o-ring.

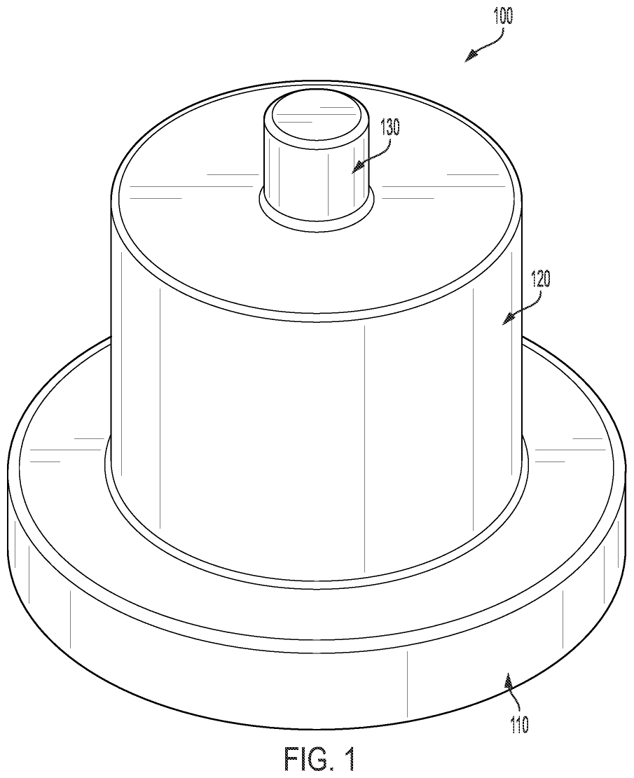

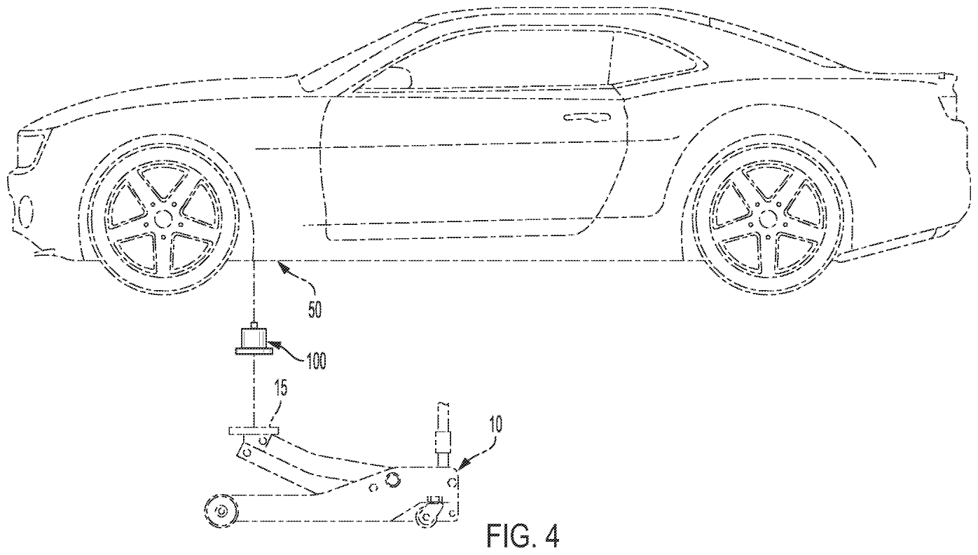

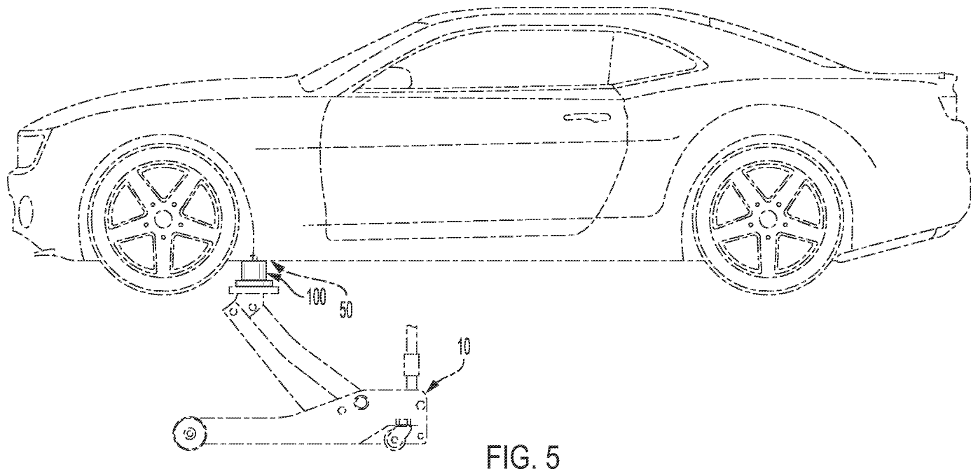

FIG. 1 depicts a perspective view of one embodiment of an adapter (100) for a vehicle jack (10 as shown in FIG. 4 and FIG. 5). As shown in FIG. 1, the adapter may comprise a puck (110), a riser (120), and a nipple (130).

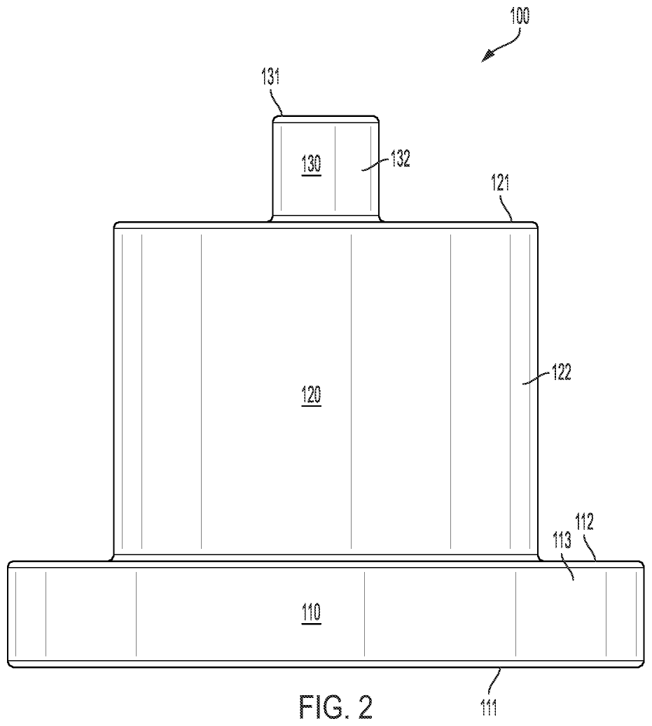

FIG. 2 shows a side view of the embodiment of an adapter shown in FIG. 1. As illustrated in FIG. 2, the puck has a puck bottom surface (111) and a puck top surface (112) opposite the puck bottom surface. Extending between the puck bottom surface and the puck top surface is a puck sidewall (113) which has a first exterior dimension.

FIG. 2 also illustrates the riser (120) extending from the puck top surface (112). As shown, the riser is attached to the puck top surface. The attachment between the riser and the puck top surface may take many forms. In some embodiments the riser may be integrally attached to the puck top surface such as by manufacturing the riser and the puck of a single integral piece of material, by welding the riser to the puck top surface, or the like. In other embodiments the riser may be removably attached to the puck top surface such as by a fastener such as a screw, a bolt, a pin, or the like. The riser has a riser top surface (121) and a riser sidewall (122) as shown in FIG. 2 with the riser sidewall having a second exterior dimension.

Further illustrated in FIG. 2 is the nipple (130) extending from the riser top surface (121). The attachment between the nipple and the riser top surface may take many forms. In some embodiments the nipple may be integrally attached to the riser top surface such as by manufacturing the nipple and the riser of a single integral piece of material, by welding the nipple to the riser top surface, or the like. In other embodiments, the nipple may be removably attached to the riser top surface such as by a fastener such as a screw, a bolt, a pin, or the like. The nipple has a nipple top surface (131) and a nipple sidewall (132) as shown in FIG. 2 with the nipple sidewall having a third exterior dimension.

FIG. 2 also shows the first exterior dimension of the puck sidewall (113) being greater than the second exterior dimension of the riser sidewall (122) and the second exterior dimension of the riser sidewall being greater than the third exterior dimension of the nipple sidewall (132). This results in a stepped appearance when viewing the adapter from the side (as shown in FIG. 2) or in cross-section.

While the stepped appearance is shown in FIG. 2, it is not required. That is to say that—in some embodiments—the first exterior dimension of the puck sidewall (113) may be less than the second exterior dimension of the riser sidewall (122). In other embodiments, the first exterior dimension of the puck sidewall may be substantially equal to or equal to the second exterior dimension of the riser sidewall such that the puck and the riser visually present the appearance of sharing a sidewall.

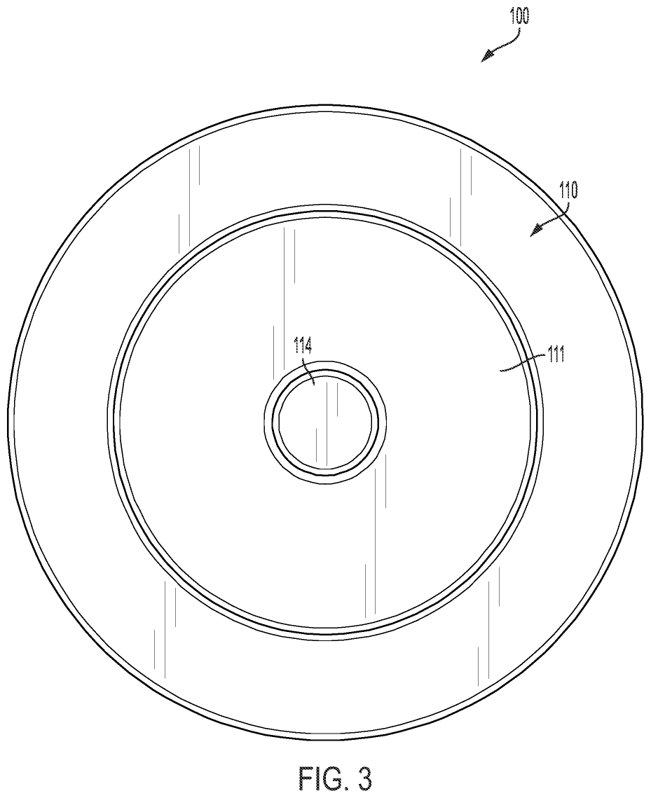

In some embodiments, such as shown in FIG. 3, the puck bottom surface (111) may comprise a nipple receiving hole (114). Preferably the nipple receiving hole will pass into the adapter (100) at a location substantially corresponding to the center point of the puck bottom surface. The nipple receiving hole—when present—preferably extends substantially parallel with a longitudinal axis of the adapter. Preferably, the nipple receiving hole will be a blind hole which passes into the adapter from the puck bottom surface without extending through the entire adapter.

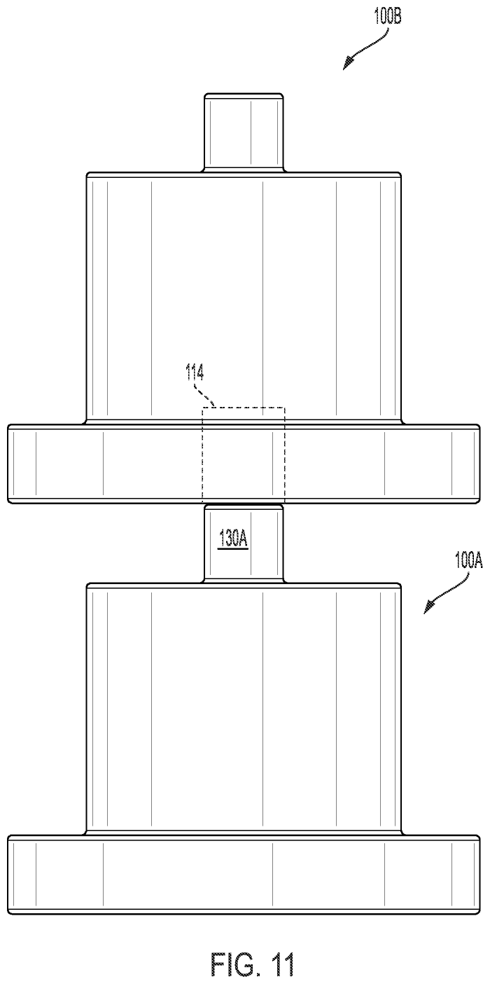

When present, the nipple receiving hole (114) allows multiple adapters to be stacked—one on top of another—in an interlocking manner as shown in FIG. 11. To do so, one simply inserts the nipple (labelled 130A in FIG. 11) of one adapter (labelled 100A in FIG. 11) into the nipple receiving hole of a second adapter (labelled 100B in FIG. 11).

FIG. 4 shows an exploded perspective view of an embodiment of the adapter (100) in use. As shown in FIG. 4, the adapter is disposed between a top surface of a jack pad (15) of the vehicle jack (10) and a surface of a vehicle chassis (50) prior to extending the jack pad towards the vehicle chassis. In some embodiments, the adapter may be associated with the top surface of the jack pad prior to extending the jack pad towards the vehicle chassis. However, in preferred embodiments, the adapter may be associated with the vehicle chassis by connecting the nipple to a corresponding hole, dimple, groove, slot, or similar structure in the vehicle chassis before extending the jack pad towards the vehicle chassis. The jack pad is then extended towards the vehicle chassis in a manner such that the top surface of the jack pad contacts the puck bottom surface (111) as shown in FIG. 5.

An example of a structure in a vehicle chassis (50) with which the adapter (100) may be associated is the frame access point in the fully covered underbody of a Rivian R1T/R1S platform truck. The fully covered underbody includes a series of round caps, any of which can be removed to allow access to the vehicle chassis. Removal of the round cap exposes a section of the vehicle chassis having a round hole into which the nipple (130) may be disposed. Removal of the round cap also leaves a slightly larger round hole in the underbody of the vehicle into which the riser (120) partially extends with the riser top surface (121) abutting against the vehicle chassis proximate to the round hole into which the nipple is disposed.

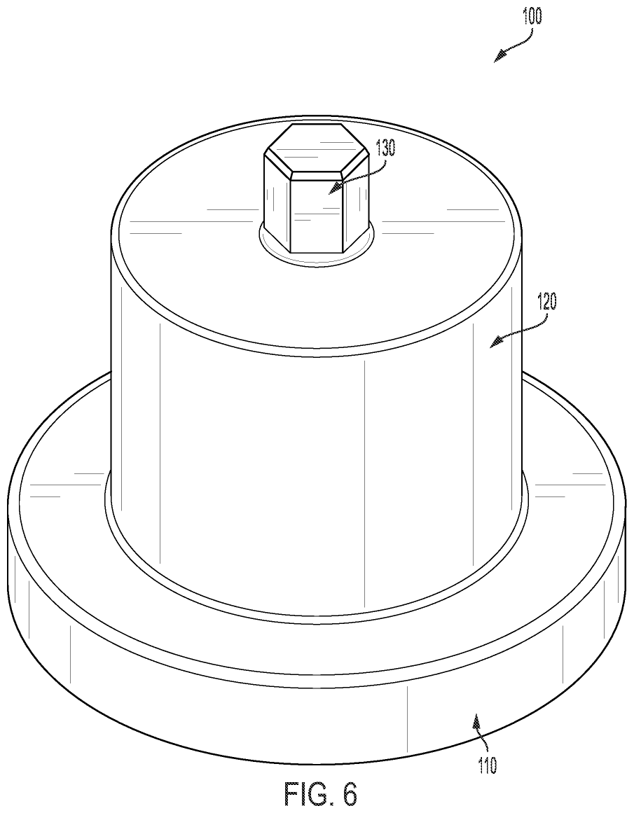

While the embodiment in FIG. 1 and FIG. 2 shows the nipple (130) having a radial cross sectional profile shape of a circle, other embodiments may exist. For example, FIG. 6 shows the nipple having a radial cross sectional profile shape of a hexagon. Other radial cross sectional profile shapes for the nipple may include an oval, a triangle, a quadrilateral, a heptagon, or an octagon. The radial cross sectional profile in any individual embodiment of the adapter (100) may be adapted to the unique size and shape of structures in the vehicle chassis (50 as shown in FIG. 4 and FIG. 5) such as hole(s), dimple(s), groove(s), slot(s), or the like to allow for a more secure connection between the adapter and the vehicle chassis during use.

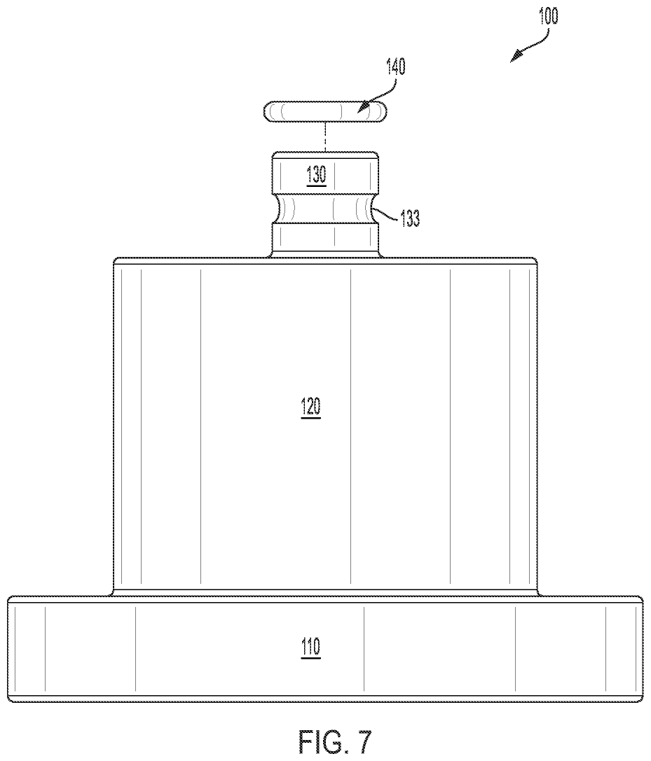

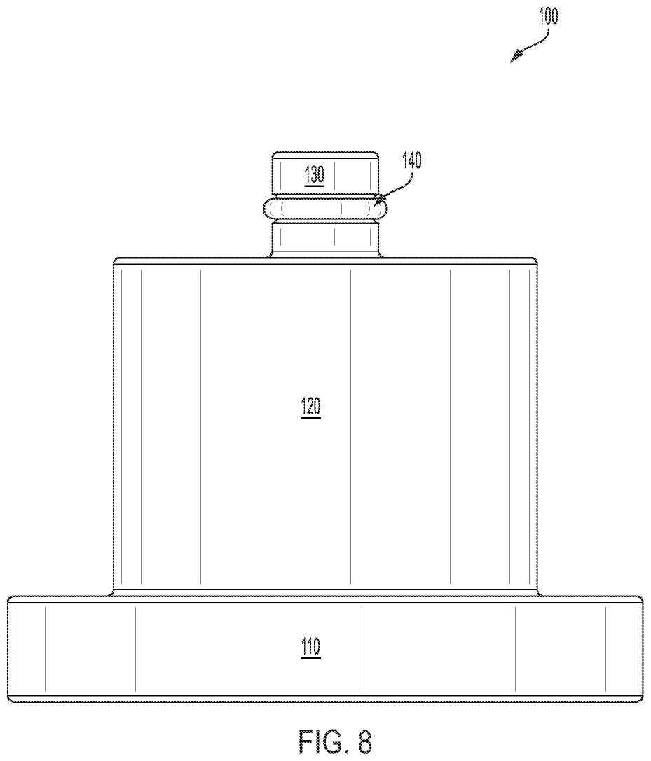

In some embodiments, the connection between the adapter (100) and the vehicle chassis (50) may be improved by use of an o-ring, a snap-ring, a spring-loaded pin, an arm, or the like. FIG. 7 and FIG. 8 show one such embodiment, which is an o-ring (140). In this embodiment, the nipple sidewall comprises an o-ring groove (133) as shown in FIG. 7. FIG. 8 shows the o-ring connected to the nipple at the o-ring groove. Alternatively, when a snap-ring is used, the nipple sidewall may comprise a snap-ring groove. When the nipple adapter is associated with the vehicle chassis (50 as shown in FIG. 4 and FIG. 5), the nipple passes into a hole in the vehicle chassis with the o-ring or snap-ring interacting with a perimeter of said hole to more securely connect the adapter to the vehicle chassis.

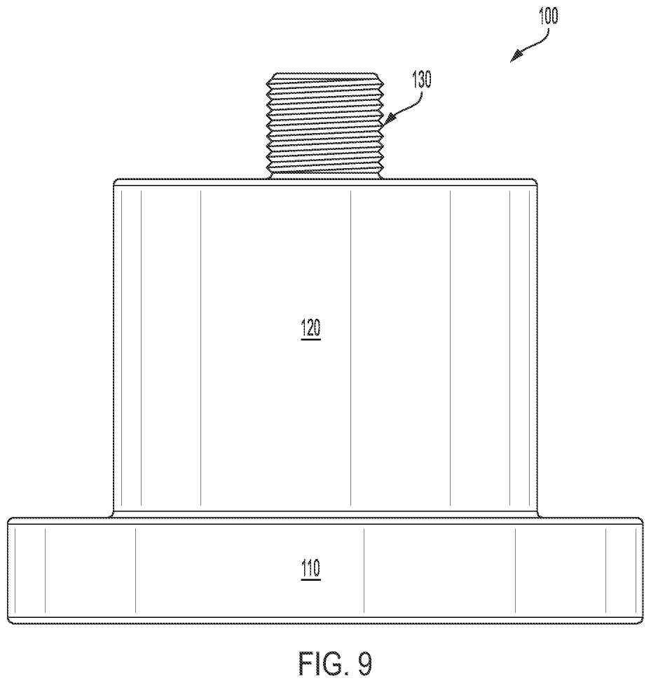

In other embodiments, the connection between the adapter (100) and the vehicle chassis (50) may be improved by threading the nipple sidewall (132) as shown in FIG. 9. The threads on the nipple sidewall may then be mated to corresponding threads of a hole in the vehicle chassis, allowing the adapter to be threaded into said hole.

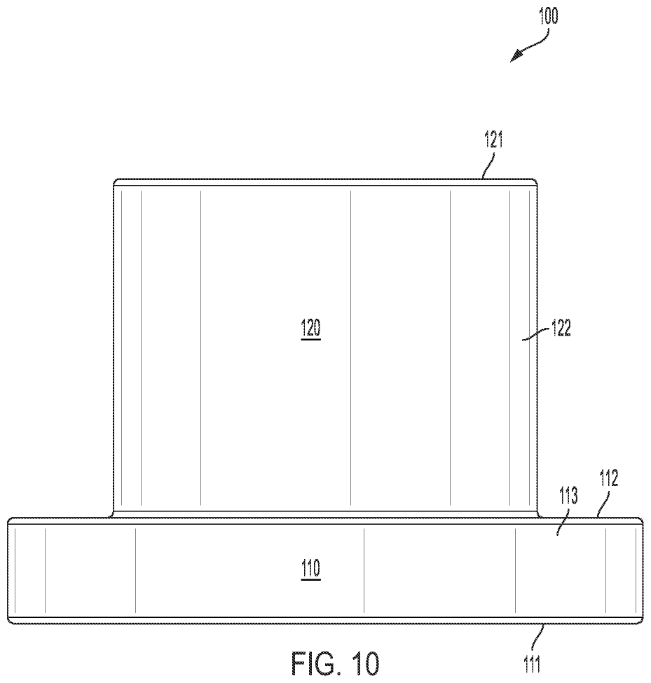

Another embodiment of an adapter (100) for a vehicle jack (10) is shown in FIG. 10. In the embodiment in FIG. 10 the adapter has no nipple. That is to say that the adapter in the embodiment in FIG. 10 comprises a puck (110) and a riser (120), but no nipple.

In the adapter in the embodiment shown in FIG. 10, the puck has a puck bottom surface (111) and a puck top surface (112) opposite the puck bottom surface. Extending between the puck bottom surface and the puck top surface is a puck sidewall (113) which has a first exterior dimension.

Further, in the embodiment shown in FIG. 10, the riser (120) is shown attached to and extending from the puck top surface (112). The attachment between the riser and the puck top surface may take many forms. In some embodiments the riser may be integrally attached to the puck top surface such as by manufacturing the riser and the puck of a single integral piece of material, by welding the riser to the puck top surface, or the like. In other embodiments the riser may be removably attached to the puck top surface such as by a fastener such as a screw, a bolt, a pin, or the like. The riser has a riser top surface (121) and a riser sidewall (122) as shown in FIG. 10 with the riser sidewall having a second exterior dimension.

Like the embodiment shown in FIG. 1, the puck bottom surface (111) in the embodiment shown in FIG. 10 is configured to associate with a top surface of a jack pad (15 as shown in FIG. 4). In the embodiment shown in FIG. 10, the riser top surface (121) may comprise a magnet. In some embodiments, the riser top surface may consist of a magnet—meaning that the entire riser top surface is fabricated from a magnet. In other embodiments, the riser top surface may be fabricated from a material other than a magnet, and a magnet may then be connected to the riser top surface by press fitting and/or by use of a fastener such as a screw, a bolt, a rivet, or the like.

The type and size of the magnet is not considered relevant and will depend upon a number of variables. In general, the type of magnet may be selected from the group consisting of rare-earth magnets, ferrite magnets, ceramic magnets, electromagnets, and combinations thereof.

Like the embodiment shown in FIG. 1, in the embodiment shown in FIG. 10, the first exterior dimension of the puck sidewall (113) is greater than the second exterior dimension of the riser sidewall (122). This results in a stepped appearance when viewing the adapter in cross-section.

While the stepped appearance is shown in FIG. 10, it is not required. That is to say that—in some embodiments—the first exterior dimension of the puck sidewall (113) may be less than the second exterior dimension of the riser sidewall (122). In other embodiments, the first exterior dimension of the puck sidewall may be substantially equal to or equal to the second exterior dimension of the riser sidewall such that the puck and the riser visually present the appearance of sharing a sidewall.

In some embodiments of the adapter shown in FIG. 10, the puck bottom surface (111) may comprise a ferromagnetic material. Non-limiting examples of ferromagnetic materials include iron, steel, nickel, and cobalt. The ferromagnetic material of the puck bottom surface—in conjunction with the magnet of the riser top surface (121) allows multiple adapters to be stacked—one on top of another, with the magnetic interaction between the magnet of one adapter securely connecting to the ferromagnetic material of a second adapter.

The various components of the adapter (100)— including the puck (110), the riser (120), and the (optional) nipple (130)— may be made of any variety of rigid materials. In general, the rigid material(s) from which the adapter components are made may be selected from the group consisting of steel, aluminum, cast iron, titanium, wood, rigid polymer materials, composite materials, and combinations thereof.

The various embodiments of an adapter disclosed herein represent improvements over the prior art. Specifically, while allowing for an increase in the height that a vehicle jack can achieve when lifting a vehicle from a surface, the adapter can easily be connected and disconnected from the vehicle jack and/or the vehicle chassis without the need to manipulate complex pins and fasteners. The nesting configurability of multiple adapters (using either a nipple receiving hole and/or a magnet as disclosed herein) also allows for variability in the amount of extra height which can be achieved by the vehicle jack by stacking, two, three, or more adapters onto one another. All of which may be achieved while maintaining a secure connection between the jack pad/saddle and the vehicle chassis which avoids or at least reduces the likelihood of the vehicle rocking, tipping, or falling from the vehicle jack.

What is claimed:

1. An adapter (100) for lifting a vehicle using a vehicle jack (10) comprising:
a puck (110) having a puck bottom surface (111), a puck top surface (112) opposite the puck bottom surface, and a puck sidewall (113) extending between the puck bottom surface and the puck top surface, said puck sidewall having a first exterior dimension;
a riser (120) extending from the puck top surface, said riser having a riser top surface (121) and a riser sidewall (122), said riser sidewall having a second exterior dimension; and
a nipple (130) extending from the riser top surface, said nipple having a nipple top surface (131) and a nipple sidewall (132), said nipple sidewall having a third exterior dimension.

2. The adapter of claim 1, wherein the nipple has a radial cross sectional profile shape selected from the group consisting of a circle, an oval, a triangle, a quadrilateral, a heptagon, a hexagon, or an octagon.

3. The adapter of claim 1, wherein the nipple sidewall comprises an o-ring groove (133), and the adapter further comprises an o-ring (140) connected to the nipple at the o-ring groove.

4. The adapter of claim 1, wherein a radial cross sectional profile shape of the nipple is a circle.

5. The adapter of claim 4, wherein the nipple sidewall is threaded.

6. The adapter of claim 4, wherein the nipple sidewall comprises a snap-ring groove, and the adapter further comprises a snap-ring connected to the nipple at the snap-ring groove.

7. The adapter of claim 1, wherein the first exterior dimension of the puck sidewall is greater than the second exterior dimension of the riser sidewall.

8. The adapter of claim 1, wherein the first exterior dimension of the puck sidewall is less than the second exterior dimension of the riser sidewall.

9. The adapter of claim 1, wherein the second exterior dimension of the riser sidewall is greater than the third exterior dimension of the nipple sidewall.

10. The adapter of claim 1, wherein the puck bottom surface comprises a nipple receiving hole (114) configured to receive a second nipple of a second adapter.

11. The adapter of claim 1, wherein the adapter comprises a rigid material selected from the group consisting of steel, aluminum, cast iron, titanium, wood, rigid polymer materials, composite materials, and combinations thereof.

12. The adapter of claim 1, wherein the puck bottom surface is configured to associate with a top surface of a jack pad (15) of the vehicle jack, and the nipple is configured to associate with a portion of a vehicle chassis (50) of the vehicle.

13. The adapter of claim 2, wherein the nipple sidewall comprises an o-ring groove (133), and the adapter further comprises an o-ring (140) connected to the nipple at the o-ring groove.

14. The adapter of claim 2, wherein the adapter comprises a rigid material selected from the group consisting of steel, aluminum, cast iron, titanium, wood, rigid polymer materials, composite materials, and combinations thereof.

15. The adapter of claim 3, wherein the first exterior dimension of the puck sidewall is greater than the second exterior dimension of the riser sidewall.

16. The adapter of claim 3, wherein the second exterior dimension of the riser sidewall is greater than the third exterior dimension of the nipple sidewall.

17. The adapter of claim 3, wherein the adapter comprises a rigid material selected from the group consisting of steel, aluminum, cast iron, titanium, wood, rigid polymer materials, composite materials, and combinations thereof.

18. The adapter of claim 13, wherein the first exterior dimension of the puck sidewall is greater than the second exterior dimension of the riser sidewall.

19. The adapter of claim 13, wherein the second exterior dimension of the riser sidewall is greater than the third exterior dimension of the nipple sidewall.

20. The adapter of claim 13, wherein the adapter comprises a rigid material selected from the group consisting of steel, aluminum, cast iron, titanium, wood, rigid polymer materials, composite materials, and combinations thereof.
